(19) United States
(12) Patent Application Publication
(10) Pub. No.: US 2006/0046746 A1
(43) Pub. Date: Mar. 2, 2006

(54) System and apparatus for managing access to wireless communication devices while present within a specified physical area

(76) Inventors: Paul Brian Ranford, Auckland (NZ); Peter George Robson, Auckland (NZ); Martin Paul Evans, Auckland (NZ); Firdosh Homavazir, Auckland (NZ); Yuming Lin, Auckland (NZ); Steven Arthur Magnell, Auckland (NZ)

Correspondence Address: Peter Robson, 5 Cyclades Place, Howick, Auckland, 1705, NZ

(21) Appl. No.: 10/929,395

(22) Filed: Aug. 31, 2004

(51) Int. Cl. H04Q 7/20

(52) U.S. Cl. 455/456.5; 455/456.1

(57) ABSTRACT

A method, system, apparatus, and computer program product is presented by which mobile communications services are managed, based upon the location of the mobile communications device within absolute three dimensional area or locale, as determined by the legal managers or owners of that locale. The locale may be subdivided into sub-areas or zones, which may be overlapping. The management services include: management of mobile devices such that specific features of the device may be enabled, disabled or otherwise actively manged while within the zone as well as the provision of alternative network services while the device is within the zone; transaction services provided to the user of the device due to its presence within the zone; information services provided to the user of the device due to its presence within the zone.

### CROSS-REFERENCE TO RELATED APPLICATIONS

This application claims the benefit of PPA Ser. No. 60/498,757, filed 2003 Aug. 29 by the present inventors.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to a system, apparatus, method and computer program product for managing access to wireless communication devices while present within a specified physical area.

2. Description of Related Art

Until recently, if a person wanted to make or receive a telephone call in a private establishment, such as a store, restaurant or business office, or a governmental one, such as a library, court or office, that person went to a telephone, if one was available, in a location of the establishment owner's choosing. In many cases, this location was somewhat removed from the rest of the establishment This was often done to provide a quiet private place for the caller, but also to avoid disturbing other patrons, interfering with the operation of the establishment or to control access to the telephone.

With the spread of wirelesses mobile communications, particularly the handheld cellular telephone, this has completely changed. A mobile wireless user can receive and place calls from anywhere that a signal between the mobile device and a wireless base station can be established. This has taken the control of an establishment's environment away from its owners or managers.

There have been a number of inventions that are designed to simply block access to wireless services within in an area. They include blocking or jamming a signal, spoofing or proxying for the base station and using public location-based services to determine to location of the mobile device and denying service. The existing methods suffer from several problems, particularly inaccuracy in delineating the boundaries of the area under control and insufficient flexibility in differentiating between the requirements of users and uses of the mobile devices.

There have also been a number of inventions and systems that provide location-based wireless services. These services have been based on determining the location of a mobile device within a relatively large area based on a specific request from the device or from an outside agent. A single location is returned via this request. They are not triggered by the presence of the mobile device within an area.

### SUMMARY OF THE INVENTION

With the evolution of features of mobile telephones to include more than just voice calling and the addition of regulatory requirements for mobile carriers, such as the provision of emergency calling from any location, the simple solution of denying all service within an locale is not enough. In addition to allowing emergency calls to be made, inbound calls to emergency workers should also be allowed. Once that is possible, it is a small step to allowing calling privileges to various classes of users based on the needs of the establishment. For example, in a business office, mobile calls may be disallowed except for certain managers.

It is an objective of this invention to provide precise location detection of mobile devices within a private location, termed a locale, and to provide differentiated access services to mobile devices within that locale or sub-areas of the locale, as defined by the owners or managers of the locale.

It may also be reasonable for an establishment to differentiate between types of communication. It may be allowable for users to send and receive text messages, since that activity would not disturb others, while disallowing voice calls, which would cause a disturbance.

Accordingly, it is an objective of this invention to provide a system and method to manage the access of individual modes of communication for a mobile device located within a managed locale. This includes the differential management of both inbound and outbound communications of all types, including, but not limited to, voice, video, text and data access.

In order that the management of wireless communication be restricted to the physically owned or managed locale, the method for detection and identification of the mobile devices must be able to precisely locate the device as being within the bounds of the locale. Once this is possible, it also becomes possible to segment that locale into smaller zones, providing differential management of mobile devices based on the zone. For example, the use of mobile telephones could be disallowed within a school building, except within a teachers' lounge; voice calls might be prohibited within the dining room of a restaurant, but allowed in the bar. It is an objective of this invention to provide a system and method for defining and monitoring multiple, potentially overlapping, management zones within a locale and to provide for differential management services specific to each zone.

Once the zonal location of a mobile device can be detected and access to the device can be managed, other services, beyond simple communications access restrictions or allowances, can be provided for the benefit of the owner or manager of the area within the zone and for the user of the device, while the device is present within a managed zone. These can be additional access-related services. For example, a restaurant might want to restrict usage of cell phones, but wish to allow patrons to be contacted. It could provide a service whereby incoming cell phone calls to patrons within the restaurant's zone are redirected to an operator and the patron is personally called a telephone outside of the restricted zone. Another service example is an option that users can subscribe to that redirects voice calls to another medium such as the conversion of a voice call to a text message in a zone where voice calls are proscribed, but SMS messages are allowed.

It is an objective of this invention to provide extended access control services with respect to mobile devices within a managed zone. These services will include, but not be limited to, intelligent redirection of inbound calls to a fixed telephone number within the locale and the ability to offer alternate means of communication with a managed device, including providing SMS access from calling voice telephones if SMS is allowed to a managed device and SMS to voice access from a managed device, if voice calling is restricted.

In addition to access-related services, locale and zone-specific transaction and information services can be directly provided to a mobile device user at the direction of the zone manager without an explicit effort on the device user's part. An example of a transaction service would be the sending of an SMS message to a device detected on entry to a facility for which an entrance fee is charged, such as a parking garage. Upon receipt of such a message and an affirmative response from the user, entry would be granted. Similarly, a user might have pre-existing account which, upon detection of the device, cause the transaction to be processed without any explicit action by the mobile device user.

It is an objective of this invention to provide a method by which the managers of a locale can actively offer a transaction service to the user of a mobile device within a zone of the locale without initiation by the mobile device user. The will include, but is not limited to, transactions which require a confirmation by the user for completion and transactions that will be automatically be completed without user interaction, if a pre-existing authorization exists. These latter transactions may or may not have user notification at the time of the transaction. Notification and confirmation may be delivered by any medium supported by the device, at the choosing of the zone operator. This will include, but is not limited to, text, voice, video and web-based methods.

Information services can provide the user with information provided by locale management as a function of being within a zone and as a condition of access to the mobile device while within the managed area. This is of particular use in a multi-zoned managed locale. For example, upon entering an establishment, an SMS-capable detected device could be sent a text message indicating that voice calls would be restricted while inside; another service could be that a mobile device user would be informed of the availability of offers within a store upon entry and the opportunity to opt-in to receive them as the user moved about the store, moving from zone to zone within.

It is an objective of this invention to provide a method by which the managers of a locale can offer information services to a user of a mobile device within a zone of the managed locale without initiation by the user. This information will only be delivered to a user while within a managed zone and the user will be allowed to opt-out of reception of the information. The information may be delivered by any medium supported by the device, at the choosing of the zone operator. This will include, but is not limited to, text, voice, video and web-based methods.

### DESCRIPTION OF THE SEVERAL VIEWS OF THE DRAWING

1. Is a drawing showing a Virtual Private Cell Locale containing overlapping Zones with a hierarchy of Zones.

2. Is a drawing showing a Virtual Private Cell Locale within cells of two carriers

3. Is a drawing showing a block diagram of the elements of an example of the system where the Virtual Private Cell Locale zone detection and identification components are connected directly to a carrier policy manager.

4. Is a drawing showing a block diagram of the elements of an example of the system where the Via Private Cell Locale zone detection and identification components are connected to the carrier-specific components via a locale-specific policy manager.

### DETAILED DESCRIPTION

A system for managing the access and services provided to mobile communications terminals while situated within a specified location using location detection subsystems, access and service policy management subsystems, transaction and information processing systems and at least one wireless network mobile switching center.

The following drawings are described for further reference.

With reference to drawing 1, the environment of a preferred embodiment is shown containing: a base station [B1] is shown along with the area of the cell it controls, the encompassing circle. The mobile terminals [T1-T4] are present within the cell. The physical area [L1] is a locale to be managed by its owners or managers. It is also termed a Virtual Private Cell. [L1]consists of three internal areas termed zones [Z1, Z2, Z3]. [Z3] overlaps [Z1] and, as will be described, is of higher priority in a hierarchy of zones. This is the simplest environment managed by the invention, as it represents a physical area served by only a single carrier.

With reference to drawing 2, which describes an alternative environment of a preferred embodiment. In this environment, the VPC Locale [L1] and its Zones [Z1, Z2, Z3] is present within the areas of two cells, each operated by a separate wireless network operator (carrier). The mobile terminals [T1-T4] are present within the cells. This environment can be extended to include as many overlapping cells as there are competing carriers.

With reference to drawing 3, a diagram of the elements of the system present in a preferred embodiment is shown. A VPC locale is shown containing a zone. The zone contains three mobile terminal Zone Detection Devices [101]. The detection devices are connected to a Zone Identification Controller [102]. While the Zone identification Controller is logically place within the domain, it is not necessarily physically within the boundaries of the VPC locale. As shown the Zone Identification Controller may be connected to detection devices monitoring other zones within the VPC locale. A mobile terminal [T] is also shown within the zone. This terminal is in communication with a wireless base station [BSC]. The base station is connected to its controlling Mobile Switching Center [MSC].

In this drawing (drawing 3), the Zone Identification Controller [102] is connected to a carrier-specific Policy Manager [201]. It may also be connected to Policy managers in other carrier domains. The Carrier Policy Manager is connected to a Carrier Locale Rule Base [202] and a Carrier Regulatory Rule Base [203] as well as a Carrier Transaction/Information Processor [204] and the carrier's MSC.

With reference to drawing 3, in an alternative preferred embodiment, the Zone Identification Controller is connected, via communication path [C5], to the carrier base station[BSC] controlling the cell in which the locale lies.

With reference to drawing 3, in an alternative preferred embodiment, the Zone Identification Controller is connected, via communication path [C6], to the Mobile Switch Center[MSC] controlling the cell in which the locale lies.

With reference to drawing 4, a diagram of the elements of the system present in an alternative preferred embodiment is shown. A locale is shown containing a zone. The zone contains three mobile terminal Zone Detection Devices [101]. The detection devices are connected to a Zone Identification Controller [102]. While the Zone identification Controller is logically place within the domain, it is not necessarily physically within the boundaries of the locale. As shown the Zone Identification Controller may be connected to detection devices monitoring other zones within the locale. A mobile terminal [T] is also shown within the zone. This terminal is in communication with a wireless base station [BSC]. The base station is connected to its controlling Mobile Switching Center [MSC].

In this drawing (drawing 4), the Zone Identification Controller [102] is connected to a Locale Policy manager [103]. The Locale Policy manager is connected to a Locale Policy Rule Base [104]. a Locale Transaction/Information Processor [105], and a carrier-specific Policy Manager [201]. It may also be connected to Policy managers in other carrier domains.

With reference to drawing 4, in an alternative preferred embodiment, the Zone Identification Controller is connected, via communication path [C5], to the carrier base station[BSC] controlling the cell in which the locale lies.

With reference to drawing 4, in an alternative preferred embodiment, the Zone Identification Controller is connected, via communication path [C6], to the Mobile Switch Center[MSC] controlling the cell in which the locale lies.

The Carrier Policy Manager is connected to a Carrier Locale Rule Base [202] and a Carrier Regulatory Rule Base [203] as well as a Carrier Transaction/Information Processor [204] and the carrier's MSC.

In a preferred embodiment, a communication path between elements of this invention may be a direct connection using a wired or wireless transport, a network connection over a public or private network, an internal connection, such a memory or internal storage where elements are implemented in a single computer system, or any combination of these transport methods.

In a preferred embodiment, the communications over a communication path may use private or public protocols including, but not limited to Internet protocols, telecommunications network protocols such as those defined in SS7 and wireless network protocols such as those defined for OSM.

In a preferred embodiment, a system for managing the access and services provided to mobile communications terminals, as shown in drawings 3 and 4. contains:
Virtual Private Cell—A Virtual Private Cell (VPC) consists of a plurality of zones that are under the control of a local owner and are to be managed using the zone management system. A zone management system may contain a plurality of VPCs.
Zones—A zone is a finite three dimensional space in which mobile telecommunications devices may be accessed by a public network carrier to which users of the mobile devices subscribe for service. Zones may overlap in space.
Detection Devices [101]—Detection devices are capable of detecting the presence of a plurality of mobile telecommunications devices and ascertaining their identification and some aspects of their location.
Zone Identification Controllers [102]—A Zone Identification Controller communicates with a plurality of detection devices. The connection between a Zone Identification Controller and a Detection Device may use wireless, wired, optical or other physical connections. Using the identification and location information provided by the detection devices and existing techniques for determining location, a zone identification controller can accurately report the presence of a plurality of mobile telecommunications devices and the zone or in which each is present. A locale may contain a plurality of Zone Identification Controllers. For reliability and availability purposes multiple Zone Identification Controllers may access any set of Device Detectors.
Carrier Policy Manager [201]—A Carrier Policy Manager takes requests from a plurality of VPC Policy managers and applies a policy (set of rules and actions), as defined in a carrier-based Policy Rule Base for each VPC. It also uses data from a Carrier Regulatory Rule Base and from User Configuration Rule Base in determining the execution of actions or responses to a VPC Policy Manager. In addition to location within the VPC, policy application may be based on additional factors including, but not limited to, events such as entry of a device into a zone, exit of a device from a zone, periodic operation while a device is in a zone, reconfiguration of a zone, user configuration data, direct requests from a VPC Policy Manager and carrier defined rules. Carrier system may contain redundant Carrier Policy Mangers for reliability and availability purposes.
Carrier VPC Policy Rule Base [202]—A Carrier VPC Policy Rule Base contains the rule sets to be applied for the plurality of zones which comprise the plurality of VPCs supported by the carrier. For each zone, a set of rules and actions may be defined for various events associated with the presence of mobile communications devices within the zone as defined above. The Carrier Policy Manager uses the Carrier VPC Policy Rule Base as a source of operational data along with the Carrier Regulatory Rule Base and the Carrier User Configuration Rule Base.
A Policy Rule Base may be implemented as part of a Carrier Policy Manager or may be a separate entity which communicates with a Carrier Policy Manager using wireless, wired, optical or other physical or network connections. A Carrier VPC Policy Rule Base is configured by the owner of the VPC. Configuration may be accomplished using any number of well-known techniques, including, but not limited to, interactive application software, configuration files and batch processing software or web-based interfaces. A Carrier system may contain redundant Carrier VPC Policy Rule Bases for reliability and availability purposes.
A rule set consists of a set of conditions and actions and may be dependent on the identification of a device and the type and model of a device, as well as the event causing the triggering of the rule execution.
Carrier Regulatory Rule Base [203]—A Carrier Regulatory Rule Base contains carrier-defined rule sets to be applied for the plurality of zones which comprise the plurality of VPCs supported by the carrier. For each zone, a set of rules and actions may be defined for various events associated with the presence of mobile communications devices within the zone as defined above. The Carrier Policy Manager uses the Carrier Regulatory Rule Base as a source of operational data along with the Carrier VPC Policy Rule Base and the Carrier User Configuration Rule Base. The Carrier Regulatory Rule Base contains rules which may modify those of the VPC owner. These may be due to carrier or regulatory requirements, hence they are defined and configured by the carrier. For example, an obvious regulatory rule might be that outbound emergency voice calls are always allowed for all VPCs.

An alternative preferred embodiment of the system also contains:
Carrier User Configuration Rule Base [204]—A Carrier User Configuration Rule Base (CUCRB) contains carrier-defined attributes associated with each mobile device customer of the carrier. The attributes are to be applied for the plurality of zones which comprise the plurality of VPCs supported by the carrier. The attributes may apply globally to all VPCs and zones or may apply to specific VPCs and zones. For each zone, the user attributes are used by set of rules and actions defined for various events associated with the presence of mobile communications devices within the zone as defined above. The Carrier Policy Manager uses the CUCRB as a source of operational data along with the Carrier VPC Policy Rule Base and the Carrier Regulatory Rule Base and may also pass the User attributes to a VPC Policy Manager on request. The CUCRB contains attributes which may modify any kept within the VPC Policy Rule Base, such as access list rules. User attributes may be be set by the carrier as part of customer configuration or due to customer preferences or requirements, hence they are defined and configured by the carrier on behalf of the customer. For example, a customer may be registered as an emergency worker, or opt-out of any information services.
In an alternative preferred embodiment, the function of CUCRB may be implemented as part of or interact with the carrier's HLR and VLR systems

An alternative preferred embodiment of the system also contains:
Carrier Transaction/Information Processor [205]—A Carrier Transaction/Information Processor (CTIP) is an adjunct service processor that takes requests from the Carrier Policy Manager and operates on them. Typically the CTIP is an IVR and/or SMS unit used to implement the voice or messaging dialogs used in the Transaction and information services executed by the carrier. It may be implemented in or interact with the carrier's existing SMS and Intelligent Network processing systems. It may interact with external Rule Base and transaction servers and networks as part of its information or transaction processing functions.
In an alternative preferred embodiment, there may be more than one CTIP. They may be differentiated by the services they provide, such as SMS messaging or IVR services.

An alternative preferred embodiment of the system also contains:
VPC Policy Manager [103]—A VPC Policy Manager provides services for the plurality of zones which comprise a VPC. VPC Policy Managers communicate with the plurality of Zone Identification Controllers within the VPC. The connection between a Zone Identification Controller and a VPC Policy Manager may use wireless, wired, optical or other physical connections. A VPC may contain redundant VPC Policy Managers for reliability and availability purposes.
A VPC Policy Manager takes the identification and zone locations for a plurality of mobile telecommunications devices and applies a policy (set of rules and actions), as defined in a VPC Policy Rule Base, for each device present in the VPC. In addition to location within the VPC, policy application may be based on additional factors including, but not limited to, events such as entry of a device into a zone, exit of a device from a zone, periodic operation while a device is in a zone, reports or requests from a Carrier Policy Manager and reconfiguration of a zone.
A VPC Policy Manager may implement policy directly, based on the rules present in its Policy Rule Base; may defer policy to the Carrier Policy Manager of the carrier to which the device user subscribes; or a combination of both. Local Policy is implemented via a series of requests to a Carrier Policy Manager and control commands to Voice/Message Response Units.
VPC Policy Rule Base [104]—A VPC Policy Rule Base contains the rule sets to be applied for the plurality of zones which comprise the VPC. For each zone, a set of rules and actions may be defined for various events associated with the presence of mobile communications devices within the zone. These events may include: entry into a zone, exit from a zone, periodic operations while in a zone and events caused by attempts to use a device within a zone. The VPC Policy Manager uses the VPC Policy Rule Base as its source of operational data.
A VPC Policy Rule Base may be implemented as part of a VPC Policy Manager or may be a separate entity which communicates with a VPC Policy Manager using wireless, wired, optical or other physical or network connections. A VPC Policy Rule Base is configured by the owner of the VPC. Configuration may be accomplished using any number of well-known techniques, including, but not limited to, interactive application software, configuration files and batch processing software or web-based interfaces. A VPC may contain redundant VPC Policy Rule Bases for reliability and availability purposes.
A rule set consists of a set of conditions and actions and may be dependent on the identification of a device and the type and model of a device, as well as the event causing the triggering of the rule execution. For example, the execution of rule set may be dependent on the identification of a phone belonging to a privileged user; or, a model of a phone that has Bluetooth capabilities may cause execution of actions which control the phone directly via hardware in the VPC without passing a request to the carrier.

An alternative preferred embodiment of the system also contains:
VPC Transaction/Information Processor [105]—A VPC Transaction/Information Processor (VTIP) is an adjunct service processor that takes requests from the VPC Policy Manager and operates on them. Typically the VTIP is an IVR and/or SMS unit used to implement the voice or messaging dialogs used in the Transaction and information services executed local to the VPC. It typically interacts directly with the PSTN and/or PLMN to communicate with the target mobile devices. It may interact with external Rule Base and transaction servers and networks as part of its information or transaction processing functions.

In an alternative preferred embodiment, there may be more than one VTIP. They may be differentiated by the services they provide, such as SMS messaging or IVR services. They may also be differentiated by the PSTN or PLMN with which they communicate.

A preferred embodiment of the system also contains a Mobile Switching Center [MSC] capable of responding to action requests made to it by a Carrier Policy Manager. In the context of this invention, the term Mobile Switching Center is used to include, but is not limited to, any of the following network-specific elements:
1. Mobile Switching Center in a GSM or PCS network
2. Mobile Telephone Switching Office in an IS-41 network
3. Gateway, Gatekeeper, Proxy Server or Firewall in an IP network.

In a preferred embodiment of the system, the MSC is also capable of responding to requests for mobile terminal identification from a plurality of Zone Identification Controllers.

In an alternative preferred embodiment, the system also contains an MSC capable of initiating mobile terminal identification notifications to a plurality of Zone Identification Controllers.

An alternative preferred embodiment of the system also contains a Base Station Controller [BSC] capable of responding to requests for mobile terminal identification from a plurality of Zone Identification Controllers. In the context of this invention, the term Base Station Controller is used to include, but is not limited to, any of the following network-specific elements:
1. Base Station Controller in a GSM or PCS network
2. Base Station in an IS-41 network
3. Access Point in an IP network.

In an alternative preferred embodiment, the system also contains a BSC capable of initiating mobile terminal identification notifications to a plurality of Zone Identification Controllers.

In a preferred embodiment, the detection devices [101] are capable of monitoring at least the control channel traffic from mobile terminals [T], normally wireless telephones, supported by the base station [BSC] technology. They listen for transmissions from mobile terminals and report the data received along with attributes relevant to a location detection method to the Zone Identification Controller [102]. Depending on the detection method, these attributes may be time of arrival of the data, signal strength, angle of arrival, phase, or other parameters.

As a terminal [T] enters a cell, either by a handover or power-on sequence, it communicates with the base station [BSC]. It also communicates with the base station when it attempts to connect to make a call or other transmission, such as send a message. It also responds to the base station when setting up to receive a call or other transmission. Periodic probes and replies may also be transmitted by the terminal, depending on the cellular technology used. It is these communications that are monitored by the detection devices.

In a preferred embodiment, a VPC locale[L1], as depicted in drawing 1, is defined as a physical three-dimensional space under the control of an owner or managers of that space. This area could be a building, a set of offices within a building, a campus or any other place under private control. A VPC locale is located, in this preferred embodiment, within the three-dimensional space of a wireless carrier communications cell controlled by a base station [B1].

In an alternative preferred embodiment, the VPC locale can span several cells.

In a preferred embodiment, a VPC locale [L1] is further subdivided into zones[Z1, Z2, Z3], which are also physical three-dimensional spaces. These are also depicted in drawing 1. As shown, Zones may overlap [Z2, Z3]. A zone represents an area in which a specific set of rules governing the use of mobile terminals will be applied to all terminals[T1, T2, T3] within a zone. When zones overlap, a hierarchy of zones will be applied and, if rules conflict, those of the zone higher in the hierarchy will prevail.

In a preferred embodiment, the Zone Identification Controller takes the data reports from the detection devices within the VPC locale and, using known methods for location detection, such as relative signal strength, angle of arrival, time difference of arrival or any other method, determines if the transmission emanates from a terminal within the VPC locale and if which zone or zones the terminal is present. It may also determine if a terminal is outside a zone.

In a preferred embodiment, where the data from the mobile terminal is not encrypted and a terminal identifier is present, the Zone Identification Controller saves the terminal identifier.

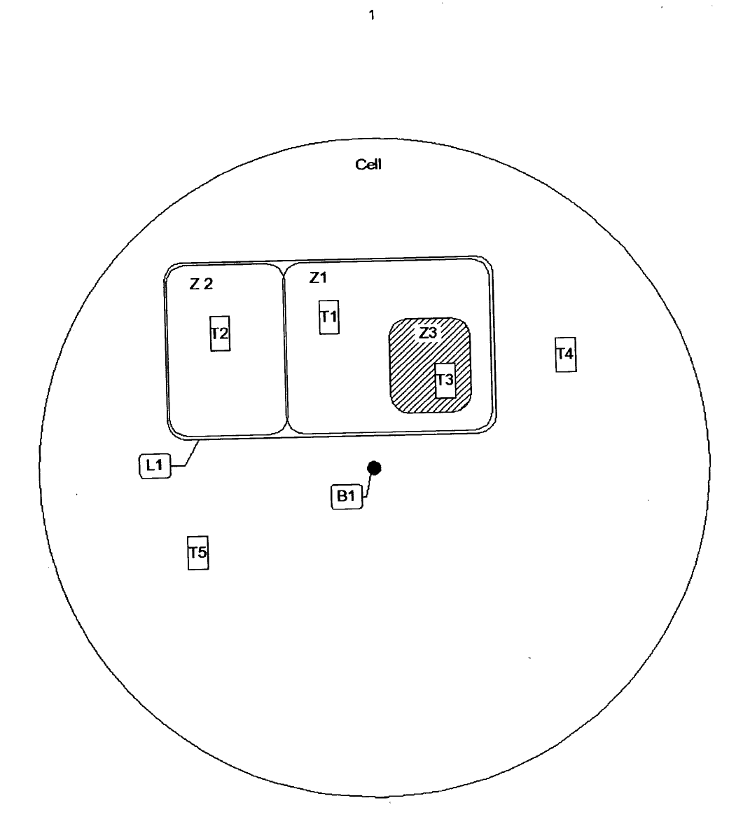

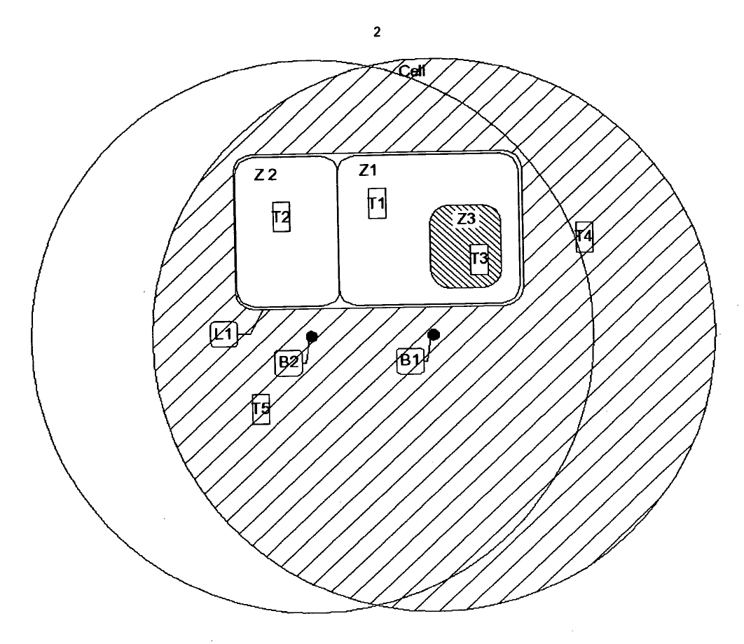

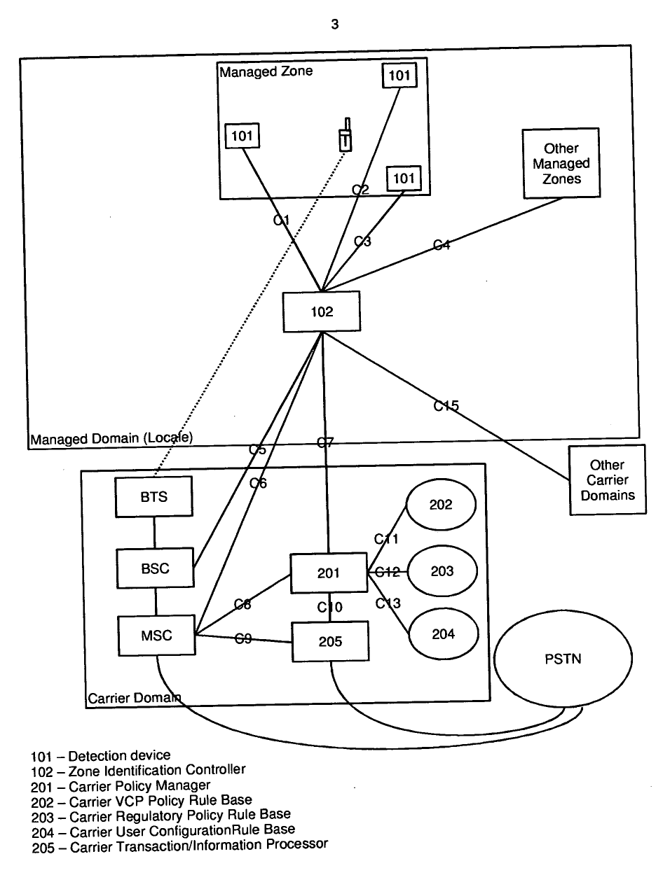

In an alternative preferred embodiment, as shown in FIGS. 3 and 4, where the data from the terminal is encrypted, the Zone Identification Controller sends the data received to the BSC via communication path [C5] and the BSC returns a terminal identifier.

In an alternative preferred embodiment, as shown in FIGS. 3 and 4,where, the data from the terminal is encrypted, the Zone Identification Controller sends the data received to the MSC via communication path [C6] and the MSC returns a terminal identifier.

In an alternative preferred embodiment, as shown in FIGS. 3 and 4, where, the data from the terminal is encrypted, the BSC sends the key for decryption and terminal identifier to the Zone Identification Controller, via communication path [C5], whenever it generates one for a terminal within the cell. The Zone Identification Controller uses the key for all data monitored from that terminal to validate the identification of the terminal and determine any terminal state.

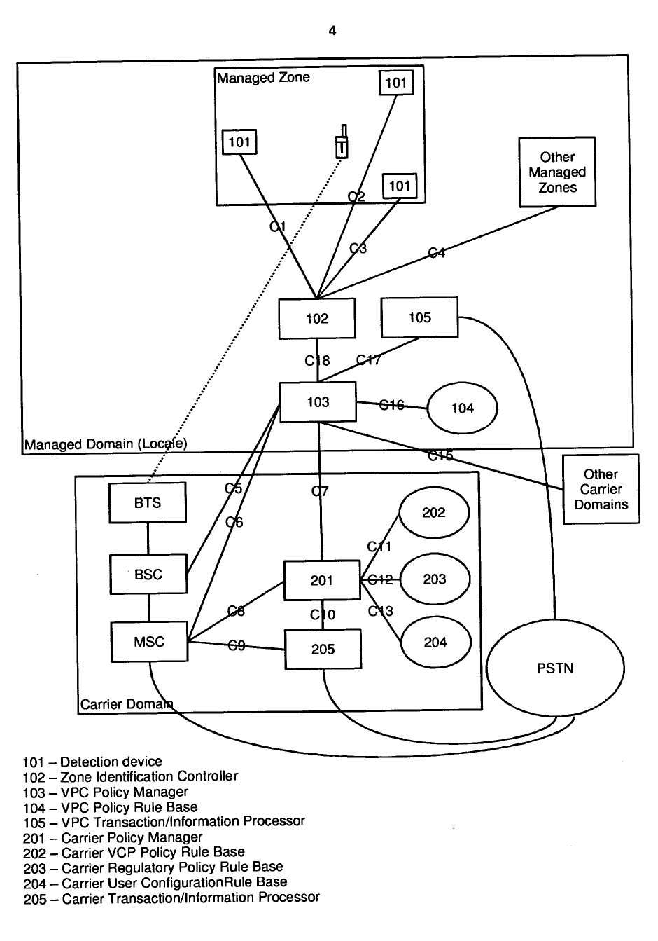

In an alternative preferred embodiment, where, the data from the terminal is encrypted, as shown in FIGS. 4 and 6, the MSC sends the key for decryption and terminal identifier to the Zone Identification Controller, via communication path [C6], whenever it generates one for a terminal within the cell. The Zone Identification Controller uses the key for all data monitored from that terminal to validate the identification of the terminal and determine any terminal state.

In a preferred embodiment, the Zone Identification Controller, as shown in FIGS. 3 and 4, whenever it determines that a terminal exists in, enters or leaves at least one zone, sends the event associated with the terminal activity which, in addition to the type of event, includes the terminal identifier, the list of zones in which the terminal appears and any additional state information associated with the terminal to the Carrier Policy manager [201] of the carrier whose Base Station is communicating with the terminal.

In an alternative preferred embodiment, where the data from a mobile terminal is encrypted and the Zone Identification Controller cannot provide a terminal identifier, the Zone Identification Controller, as shown in drawing 3, whenever it determines that a terminal exists in, enters or leaves at least one zone, sends the event associated with the terminal activity which, in addition to the type of event, includes the encrypted data, the list of zones in which the terminal appears and any additional state information associated with the terminal to the Carrier Policy manager [201] of the carrier whose Base Station is communicating with the terminal.

The types of events that can be reported to the Carrier Policy Manager include, but are not limited to:
1. A Mobile Terminal has entered at least one zone.
2. A Mobile Terminal has exited at least one zone.
3. A Mobile Terminal has is present in at least one zone.
4. A Mobile Terminal has powered on and is present in at least one zone.
5. A Mobile Terminal has powered down.
6. A Mobile Terminal has appeared in at least one zone. Its presence has been detected, but not via power up or entry in the zone or zones.
7. A Mobile Terminal has been lost. It has disappeared from zones, but not via power down or exit.
8. A Mobile Terminal, present in at least one zone, is attempting a call.
9. A Mobile Terminal, present in at least one zone, is attempting SMS or other data communications.

In an alternative preferred embodiment, as shown in drawing 4, the Zone Identification Controller, whenever it determines that a terminal exists in, enters or leaves at least one zone, sends the event associated with the terminal activity which, in addition to the type of event, includes the terminal identifier, the list of zones in which the terminal appears and any additional state information associated with the terminal to a VPC Policy manager [103].

In an alternative preferred embodiment, where the data from a mobile terminal is encrypted and the Zone Identification Controller cannot provide a terminal identifier, the Zone Identification Controller, as shown in drawing 4, whenever it determines that a terminal exists in, enters or leaves at least one zone, sends the event associated with the terminal activity which, in addition to the type of event, includes the encrypted data, the list of zones in which the terminal appears and any additional state information associated with the terminal to a VPC Policy manager [103].

In a preferred embodiment, as shown in drawing 4, the VPC Policy Manager receives events from a Zone Identification Controller. If the terminal referenced in the event is not currently known by the VPC Policy Manager, the policy manager creates a state object or variable for the terminal. For each zone referenced in the event the policy manager queries the VPC Policy Rule Base for the rules associated with the zone and applies each rule found.

In an alternative preferred embodiment, as shown in drawing 4, the VPC Policy Manager receives events from a Zone Identification Controller where the terminal is not identified and the encrypted data is included as part of the event. The VPC Policy Manager sends a request to identify the terminal, with the encrypted data to the MSC of the carrier associated with the base station with which the terminal was communicating. In this case the VPC Policy manager caches the event until a response event is received from the MSC, at which time the cached event is modified to contain the terminal identifier and handled as in the previous paragraph.

In a preferred embodiment, as shown in drawing 4, the VPC Policy Manager receives other types of events in addition to the events posted by the Zone Identification Controller. These include:
Policy Manager Notifications—A Carrier Policy Manager [201] connected to the VPC Policy manager may send notifications of actions performed and Carrier status back to the the VPC Policy Manager.
Timer events—The VPC Policy Manager can, as part of rule processing, set timers to schedule future periodic or timed actions.
Configuration events—The VPC Policy Manager and the VPC Policy Rule Base [ 104] are configurable, but must also be continuously available. The configuration of the system, which cause changes to the Rule Base, should be finalized by the posting of a configuration event to allow the runtime system to synchronize itself to configuration changes.
Transaction/Information Processor (TIP) events—As will be described below, the VPC Policy Manager may post requests to VPC Transaction/Information Processor [105], to provide IVR, SMS or transaction services. The VPC TIP will generate response events as the requests are serviced.
System events—System events may be generated by the VPC Policy Manager or other components of system. They are typically global events that indicate some change in system status, such as the failure of a system component or connection.

A rule is defined by a trigger event, as defined above, the zones in which the rule applies, a set of conditions and a set of actions. If the event occurs, the rule will tested and possibly executed. The set of conditions is a conditional expression, whose arguments are terminal, zone, VPC or system state variables, that must evaluate to true or false. The set of actions is a list of actions to be performed for this rule. Actions describe the operations that are to be performed as a result of the event and may be conditionally executed depending on the state of the terminal as known by the policy manager, the state of the policy manager or any element of the system.

In a preferred embodiment, as shown in drawing 4, the actions of a rule are applied if the event type and zone match those defined in the rule and the conditions evaluate to true. If there are conflicting actions and they are for the same zone, those of the latest rule evaluated will be applied. If there are conflicting actions when the event occurs in more than one zone, the actions associated with the zone highest in the zone hierarchy are applied.

In a preferred embodiment there are several types of actions:
1. Access Actions—These actions describe how access services available to a mobile terminal are to be managed.
2. Transaction/Information Actions—These actions define requests to be made to a Transaction/Information Processor.
3. VPC Locale Actions—These actions are executed by the VPC Policy Manager
4. Carrier Actions—These actions are executed by the Carrier Policy Manager

In a preferred embodiment, as shown in drawing 4, there are two major classes of actions, those which are applied locally by system elements associated with the VPC Locale and those associated with the Carrier with which the terminal causing the event is communicating. VPC locale actions include, but are not limited to:
1. Set the value of a terminal, zone or VPC locale state variable.
2. Set a timer and generate a timer event on timer expiration
3. Generate a local event
4. Send a request to a VPC TIP [105]
5. Cancel a request to a VPC TIP [105]

Actions 1-3 are performed locally by the VPC Policy Manager and actions 4-5 are performed by sending a message to a VPC TIP via communication path [C17] in drawing 4.

In a preferred embodiment, as shown in drawing 4, Carrier actions, Access Actions and Carrier Transaction/Information Actions are applied indirectly. Both the actions and the events that triggered them are sent to the appropriate Carrier Policy Manager (CPM) [201] by the VPC Policy manager.

In a preferred embodiment, access actions are used to manage the use of access services available to a mobile terminal while in a zone of the VPC locale. The types of access services that may be managed using actions include, but are not limited to:
1. Ringing (restrict/unrestrict)—This will, if supported by the network and terminal, allow the management of audible ringing of the mobile terminal. Unless otherwise restricted, calls and other modes of communication would be allowed.
2. Inbound Audio calls (restrict/unrestrict/redirect)—Calls allowed by regulation or by an explicit access list defined by the managers of a VPC locale would still be completed, e.g emergency workers, regulatory VIPs.
3. Outbound Audio calls (restrict/unrestrict)—Emergency (e.g. E911) calls would always be allowed. Regulatory or access list access would be allowed.
4. Inbound Video calls (restrict/unrestrict/redirect)—Calls allowed by regulation or by explicit access list would still be completed, e.g emergency workers, regulatory VIPs. Disabling video separate from audio would be useful in situations where hands-free (and eye-free) usage is required.
5. Outbound Video calls (restrict/unrestrict)—Emergency (e.g. E911) calls would always be allowed. Regulatory or access list access would be allowed. Disabling video separate from audio would be useful in situations where visual access is restricted for privacy of the location.
6. Inbound SMS (restrict/unrestrict)—Regulatory or access list access would be allowed.
7. Inbound SMS if ring cannot be disabled (restrict/unrestrict)—Regulatory or access list access would be allowed.
8. Outbound SMS (restrict/unrestrict)—Regulatory or access list access would be allowed.
9. Inbound MMS (restrict/unrestrict)—Regulatory or list access would be allowed.
10. Inbound MMS if ring cannot be disabled (restrict/unrestrict) Regulatory or access list access would be allowed.
11. Outbound MMS (restrict/unrestrict)—Regulatory or access list access would be allowed.
12. WAP access (restrict/unrestrict)—Regulatory or access list access would be allowed.
13. Mobile Terminal (enable/disable)—This would only be allowed within authorized VPC locales such as a police station, defense installation or government office where security requires it. This may be overridable by access list or combined with local diversion based on user class.

In a preferred embodiment, as shown in drawing 4, actions sent to the CPM include, but are not limited to:
1. Restrict an access service—This is used to request access service restriction by the MSC controlling communications with the Mobile Terminal. It would specify the type of service (e.g. Inbound voice calls) to be restricted. This may have a time limit associated with it.
2. Redirect an access service—This is used to implement service redirection at the MSC level. It would specify the type of service (e.g. Inbound voice calls) for which redirection will be implemented. It implies that there is no specialized processing to be done via the CPM and that normal network services would apply. In this model, if inbound voice calls were redirected to an operator (e.g., in a restaurant for call delivery to a patron), the incoming call would attempt to connect to the specified number. If the redirect attempt failed the MSC would then handle it just as if the Mobile Terminal were turned off or out of any service area. This may have a timeout associated with it.
3. Redirect a priority access service—This is used to implement service redirection at the MSC level. It would specify the type of service (e.g. Inbound voice calls) for which redirection of inbound priority calls will be implemented. It implies that there is no specialized processing to be done via the CPM and that normal network services would apply. In this model, if inbound voice calls were redirected to an operator (e.g., in a restaurant for call delivery to a patron) , the incoming call would attempt to connect to the specified number. If the redirect attempt failed the MSC would then handle it just as if the Mobile Terminal were turned off or out of any service area. This may have a timeout associated with it. Priority calls are calls to subscribers who are designated as Emergency workers, Carrier-defined Priority subscribers or on a VPC Locale management configured access list.
4. Unrestrict an access service—This would be used to reverse a restriction or redirection at the MSC level.
5. Notify on an access service attempt—This is used to implement service restrictions at the VPM level. It would specify the type of service (e.g. Inbound voice calls) for which notification will be given. When a service attempt of the type specified by this request is processed at the MSC, e.g. an incoming call, the MSC would send a notification event to the CPM, which would then forward it to the appropriate VPM.
6. Perform access control action—This is an action, normally generated as the result of an access service notification event sent to the VPC Policy Manager by the CPM. It defines a control action to be applied to a pending access service attempt. The VPM would determine the disposition of the attempt (e.g. reject, send to voicemail, redirect to IVR for voice-to-sms conversion, etc.) and send the response to the CPM, which would then handle it appropriately usually by sending a request to the MSC.
7. Terminate notification—This would be used to indicate that notification on a service attempt is no longer needed.
8. Break connection—This would be used to tell the MSC to drop an existing call on an ME. It would most likely be used when a user entered a restricted zone while on a call.
9. Request terminal attributes—This is used to request that the CPM return an event containing the current identification of the Mobile Terminal, such as ISDN number, and its current status.
10. Send a request to a Carrier TIP [205]
11. Cancel a request to a Carrier TIP [205]

In a preferred embodiment, as shown in drawing 4, a Carrier Policy Manager (CPM) [201] is connected to at least one VPC Locale Policy Manager (VPM) [103] and receives events and the actions generated by the VPM as the result of those events.

In an alternative preferred embodiment, as shown in drawing 3, a CPM is connected to at least one VPC Local Zone Identification Controller (ZIC) [102] and receives events directly from the ZIC. In this embodiment, the VPC Locale does not contain its own VPM.

In a preferred embodiment, a CPM may service events and actions for a single VPC or for multiple VPCs. The VPCs may be owned and managed by a plurality of subscribers to the access and service management services offered by the Carrier.

In a preferred embodiment, a CPM receives events from a ZIC or VPM. If the mobile terminal referenced in the event is not currently known by the CPM, the policy manager creates a state object or variable for the terminal. For each zone referenced in the event the policy manager queries the Carrier VPC Policy Rule Base (CVPRB) [202], the Carrier Regulatory Rule Base (CRRB) [203] and the Carrier User Configuration Rule Base (CUCRB) [204] for the rules associated with the zone and applies each rule found.

In an alternative preferred embodiment, as shown in drawing 3, the CPM receives events from a ZIC where the terminal is not identified and the encrypted data is included as part of the event. The CPM sends a request to identify the terminal, with the encrypted data to the MSC of the carrier associated with the base station with which the terminal was communicating. In this case the CPM caches the event until a response event is received from the MSC, at which time the cached event is modified to contain the terminal identifier and handled as in the previous paragraph.

In an alternative preferred embodiment, as shown in drawing 3, the CPM receives keys for decrypting the terminal data from the MSC as the keys are generated for mobile terminals within the cell containing the VPC. In this embodiment, events from a ZIC where the terminal is not identified and the encrypted data is included as part of the event are decoded directly by the CPM.

In a preferred embodiment, a CPM receives other types of events in addition to the events posted by a ZIC or VPM. These include:
MSC Notification events—An MSC connected to a CPM may send notifications of actions performed and Carrier status back to the the CPM.
Timer events—The CPM can, as part of rule processing, set timers to schedule future periodic or timed actions.
Configuration events—A CPM, CVPRB, CRRB and CUCRB are each configurable, but must also be continuously available. The configuration of the system, which cause changes to the Rule Base, should be finalized by the posting of a configuration event to allow the runtime system to synchronize itself to configuration changes.
Carrier Transaction/Information Processor (CTIP) events—As will be described below, the CPM may post requests to at least one Carrier Transaction/Information Processor [205], to provide IRR, SMS or transaction services. The CTIP will generate response events as the requests are serviced.
System events—System events may be generated by the CPM or other components of system. They are typically global events that indicate some change in system status, such as the failure of a system component or connection.

In a preferred embodiment, the types of rules and actions processed by the CPM include those defined for the VPM above.

In a preferred embodiment, a CPM may also generate additional actions including, but not limited to:
1. Send notification event to VPM

In a preferred embodiment, for each event received, the CPM first searches the CVPRB for rules matching the event and evaluates them as described for the VPM above, generating actions to be executed. The actions are them merged with any actions generated by a VPM and sent with the event to the CPM. If there are conflicting actions,a new action generated by the CPM will replace the preexisting conflicting action.

In a preferred embodiment, for each event received, the CPM secondly searches the CRRB for rules matching the event and evaluates them as described for the VPM above, generating actions to be executed. The actions are them merged with any previously generated actions. If there are conflicting actions,a new action generated by the CPM will replace the preexisting conflicting action.

In a preferred embodiment, for each event received, the CPM thirdly searches the CUCRB for rules matching the event and evaluates them as described for the VPM above, generating actions to be executed. The actions are them merged with any previously generated actions. If there are conflicting actions,a new action generated by the CPM will replace the preexisting conflicting action.

In a preferred embodiment, the CPM then sends each resulting actions to the target system component for execution. The target system components may include, but are not limited to the CPM itself, the MSC controlling the mobile terminal associated with the action, or a CTIP.

In a preferred embodiment, as shown in drawing 3, the CPM may also send actions to the VPC Locale ZIC in which associated mobile terminal is present.

In a preferred embodiment, as shown in drawing 4, the CPM may also send actions to the VPM for the VPC locale in which associated mobile terminal is present.

In a preferred embodiment, the MSC controlling mobile terminals in the cells in which a at least one VPC Locale exists, receives action requests from at least one CPM. The action requests sent to an MSC are those used to manage mobile terminal access to the network or are requests for information or notification of mobile terminal status. These actions include, but are not limited to:
1. Restrict an access service—This is used to request access service restriction by the MSC controlling communications with the Mobile Terminal. It would specify the type of service (e.g. Inbound voice calls) to be restricted. This may have a time limit associated with it.
2. Redirect an access service—This is used to implement service redirection at the MSC level. It would specify the type of service (e.g. Inbound voice calls) for which redirection will be implemented. It implies that there is no specialized processing to be done via the CPM and that normal network services would apply. In this model, if inbound voice calls were redirected to an operator (e.g., in a restaurant for call delivery to a patron), the incoming call would attempt to connect to the specified number. If the redirect attempt failed the MSC would then handle it just as if the Mobile Terminal were turned off or out of any service area. This may have a timeout associated with it.
3. Redirect a priority access service—This is used to implement service redirection at the MSC level. It would specify the type of service (e.g. Inbound voice calls) for which redirection of inbound priority calls will be implemented. It implies that there is no specialized processing to be done via the CPM and that normal network services would apply. In this model, if inbound voice calls were redirected to an operator (e.g., in a restaurant for call delivery to a patron) , the incoming call would attempt to connect to the specified number. If the redirect attempt failed the MSC would then handle it just as if the Mobile Terminal were turned off or out of any service area. This may have a timeout associated with it. Priority calls are calls to subscribers who are designated as Emergency workers, Carrier-defined Priority subscribers or on a VPC Locale management configured access list.
4. Unrestrict an access service—This would be used to reverse a restriction or redirection at the MSC level.
5. Notify on an access service attempt—This is used to implement service restrictions at the VPM level. It would specify the type of service (e.g. Inbound voice calls) for which notification will be given. When a service attempt of the type specified by this request is processed at the MSC, e.g. an incoming call, the MSC would send a notification event to the CPM, which would then forward it to the appropriate VPM.
6. Perform access control action—This is an action, normally generated as the result of an access service notification event sent to the VPC Policy Manager by the CPM. It defines a control action to be applied to a pending access service attempt. The VPM would determine the disposition of the attempt (erg. reject, send to voicemail, redirect to IVR for voice-to-sms conversion, etc.) and send the response to the CPM, which would then handle it appropriately usually by sending a request to the MSC.
7. Terminate notification—This would be used to indicate that notification on a service attempt is no longer needed.
8. Break connection—This would be used to tell the MSC to drop an existing call on an ME. It would most likely be used when a user entered a restricted zone while on a call.
9. Request terminal attributes—This is used to request that the CPM return an event containing the current identification of the Mobile Terminal, such as ISDN number, and its current status.

The MSC responds to action requests by providing the service requested and returning any responses as event messages to the the CPM.

In a preferred embodiment, as shown in drawing 4, the system may contain at least one VPC Transaction/Information Processor (VTIP). This element of the system connects to the communication network on which a mobile terminal being managed by the system is present. This connection is outside the bounds of the system being described. The VTIP receives actions from the VPM as requests to execute a transaction or information service with respect to a particular mobile terminal. These actions include, but are not limited to:
1. Execute Transaction or Information Request for a specified mobile terminal
2. Cancel Transaction or Information Request for a specified mobile terminal.

The specific details of the service provided are configured within the VTIP and are not part of this invention. They are expected to be IVR, SMS or transaction services provided by existing systems and techniques which interact directly with a given mobile terminal using standard communication interfaces with the network on which the terminal is present.

The VTIP responds to action requests by providing the service requested and returning any responses as event messages to the VPM. A single VTIP action request may generate multiple events. The types of events to be returned are indicated in the action request and my include, but are not limited to:
1. Send event at start of action execution
2. Send event on completion action execution
3. Send event of completion of action cancellation

In a preferred embodiment, as shown in drawing 4, the VTIP may be implemented as one or more separate elements, each capable of a single mode of service such as a Voice Processing System, Text Message Processing system or Transaction Processing system. A VTIP may also be implemented as part of the VPM.

In a preferred embodiment, as shown in drawing 3, the system may contain at least one Carrier Transaction/Information Processor (CTIP). This element of the system connects to the communication network on which a mobile terminal being managed by the system is present. This connection is outside the bounds of the system being described. The CTIP receives actions from the CPM as requests to execute a transaction or information service with respect to a particular mobile terminal. These actions include, but are not limited to:

3. Execute Transaction or Information Request for a specified mobile terminal
4. Cancel Transaction or Information Request for a specified mobile terminal.

In a preferred embodiment, as shown in drawing 3, a CTIP may provide information or transaction service for a plurality of the VPC locales managed via the CPM to which it is connected.

The specific details of the service provided are configured within the CTIP and are not part of this invention. They are expected to be IVR, SMS or transaction services provided by existing systems and techniques which interact directly with a given mobile terminal using standard communication interfaces with the network on which the terminal is present.

The CTIP responds to action requests by providing the service requested and returning any responses as event messages to the CPM. A single CTIP action request may generate multiple events. The types of events to be returned are indicated in the action request and my include, but are not limited to:
4. Send event at start of action execution
5. Send event on completion action execution
6. Send event of completion of action cancellation

In a preferred embodiment, as shown in drawing 3, the CTIP may be implemented as one or more separate elements, each capable of a single mode of service such as a Voice Processing System, Text Message Processing system or Transaction Processing system. A CTIP may also be implemented as part of the CPM.

We claim:

1. A system for managing the access and services provided to wireless communications terminals, comprising:
a) at least one location detection system,
b) an access and service policy management system
c) zero or more transaction and information processing systems and
d) at least one wireless network connection controller.

2. The system of claim 1 wherein the network connection controller is a mobile switching center and the wireless communications terminal is a:
a) mobile telephone,
b) pager,
c) wireless-capable personal digital assistant,
d) wireless-capable personal computer,
e) wireless security monitoring device,
f) wireless telemetry device or
g) wireless data capture device.

3. The system of claim 2, wherein a location, termed a locale, is a three-dimensional space defined by a set of connected bounding coordinates.

4. The system of claim 2, wherein a locale is within a cell of each base station of the mobile communications network.

5. The system of claim 2, wherein a locale may contain at least one zone, where a zone is a three-dimensional space defined by a set of connected bounding coordinates, lying within the locale.

6. The system of claim 2, wherein the zones of a locale may be overlapping in space

7. The system of claim 2, wherein the location of a wireless communications terminal can be determined to be within a zone or set of overlapping zones.

8. The access and service policy management system of claim 1 comprising:
a) a locale policy management system and
b) at least one carrier policy management system

9. The system of claim 8, wherein there is a locale policy management system comprising a locale policy manager and a locale rule base.

10. The system of claim 8, wherein there is a carrier policy management system comprising:
a) a carrier policy manager,
b) a carrier locale rule base and
c) a carrier configured rule base.

11. The system of claim 8 wherein the locale policy management system is omitted.

12. The system of claim 8, wherein the rule bases are stored in a database.

13. The system of claim 8, wherein messages, describing events, are received from:
a) at least one location detection system,
b) at least one mobile switching system and
c) at least one transaction and information processing system.

14. The system of claim 8, wherein the events received from a location detection system can include, but are not limited to:
a) terminal has entered at least one zone;
b) terminal has exited at least one zone;
c) terminal is present in at least one zone;
d) terminal has powered on and is present in at least one zone;
e) terminal has powered down; terminal has appeared in at least one zone;
f) terminal has been lost;
g) terminal is attempting call in at least one zone;
h) terminal attempting SMS or other messaging in at least one zone.

15. The system of claim 8, wherein the events received from a mobile switching center can include, but are not limited to:
a) access number identification response for a terminal,
b) notification of service attempt to or by a terminal,
c) terminal has entered a cell,
d) terminal has left a cell.

16. The system of claim 8, wherein the events received from a transaction and information processing system can include, but are not limited to:
a) service execution to a terminal completed,
b) service execution to a terminal failed,
c) service execution to a terminal canceled.

17. The system of claim 8, wherein events received are internally generated and can include, but are not limited to:
a) timer related to a terminal has expired,
b) system status has changed.

18. The system of claim 8, wherein messages, describing actions to be taken, are sent to at least one mobile switching center and at least one transaction and information processing system.

19. The system of claim 8, wherein the actions sent to a mobile switching center can include, but are not limited to:
a) return the access identifier for a terminal,
b) restrict a specific set of access services to a terminal,
c) remove a restriction on a specific set of access services to a terminal,
d) redirect a specific set of access services to a terminal,
e) send a notification event on an attempt to use any of a specific set services to or from a terminal,
f) terminate a notification events provided on an attempt to use any of a specific set services to or from a terminal,
g) terminate an existing service to a terminal.

20. The system of claim 8, wherein the actions sent to a transaction and information processing system include, but are not limited to:
a) send a notification event on completion of a service to a terminal,
b) terminate the sending of a notification event, execute a specified service to a terminal,
c) cancel the execution of a specified service to a terminal.

21. The system of claim 8, wherein the access services defined in an action to the mobile switching center can include, but are not limited to:
a) inbound voice call,
b) outbound voice call,
c) inbound SMS message,
d) outbound SMS message,
e) inbound video call,
f) outbound video call,
g) outbound data request,
h) inbound data service.

22. The system of claim 8, wherein each rule base contains a set of rules for each zone of the locale being managed.

23. The system of claim 8, wherein the locale rule base contains the rule sets pertaining to a single locale.

24. The system of claim 8, wherein the carrier locale rule base and the carrier rule bases contain rule sets pertaining to each of the locales served by the mobile network provider.

25. The system of claim 8, wherein the locale rule base and the carrier locale rule base for a specific locale may be configured by the manager of that locale.

26. The system of claim 8, wherein the carrier rule base is configured by the mobile network provider.

27. The system of claim 8, wherein the rules for given zone are applied using the locale rule base, if present, then the carrier locale rule base and finally the carrier rule base, where the latest applicable rules override any earlier conflicting rules.

28. The system of claim 8, wherein, a rule is defined by:
a) a triggering event,
b) the locale and zone in which it occurs
c) a set of matching conditions
d) a set of actions to be performed if the event occurs and the matching conditions are satisfied.

29. An apparatus, the locale policy manager, comprising:
a) the means to set up communications links with the location detection systems of a locale;
b) the means to communicate with the location detection systems of a locale;
c) the means to configure the locale rule base;
d) the means to query the locale rule base;
e) the means to formulate actions to be taken to manage the access and services to a wireless communications terminal based on events received from a location detection system and the rules to be applied based on those events;
f) the means to set up a communications link with at least one carrier policy manager;
g) the means to communicate the events and actions derived from those events to at least one carrier policy manager.

30. An apparatus, the carrier policy manager, comprising:
a) the means to configure the a carrier locale configured rule base;
b) the means to configure a carrier configured rule base;
c) the means to query the carrier locale configured rule base;
d) the means to query the carrier configured rule base;
e) the means to set up a communications link with a carrier mobile switching center;
f) the means to communicate actions to be taken to the carrier mobile switching center;
g) the means to set up a communications link with a transaction and information processing system;
h) the means to communicate actions to be taken to the transaction and information processing system;
i) the means to formulate actions to be taken to manage the access and services to a wireless communications terminal based on events received from at least one location detection system and the rules, as provided by a carrier configured rule base and a carrier locale configured rule base, to be applied based on those events;
j) the means to formulate actions to be taken to manage the access and services to a wireless communications terminal based on events and actions received from at least one locale policy manager and the rules, as provided by a carrier configured rule base and a carrier locale configured rule base, to be applied based on those events.

31. An apparatus, the transaction and information processor, comprising:
a) the means to set up a communications link with a carrier policy manager or a locale policy manager;
b) the means to accept request actions to be taken from a carrier policy manager or a locale policy manager;
c) the means to execute information or transaction actions with respect to a wireless terminal;
d) the means to return response events to the requesting policy manager;
e) the means to execute information dialogs, based on received request actions, with a specified terminal where such dialogs may include, but are not limited to interactive voice response scripts, text or multimedia message dialogs,
f) the means to perform transaction processing due to a requested action specifying the identification of the wireless terminal and the locale and zone in which it present,
g) the means to execute any combination of functions a) to f).
